(19) United States
(12) Patent Application Publication
(10) Pub. No.: US 2019/0359052 A1
(43) Pub. Date: Nov. 28, 2019

(54) AN ASSEMBLY FOR A DIFFERENTIAL UNIT OF A VEHICLE

(71) Applicant: VOLVO TRUCK CORPORATION, S-405 08 Göteborg (SE)

(72) Inventors: Thomas BARILLOT, Mornant (FR); Serge VANANTY, Chassieu (FR); Yan DEPOORTER, Lyon (FR); Michael JOLIET, Montseveroux (FR); Chris CLEZARDIN, Saint Maurice sur Dargoire (FR)

(73) Assignee: VOLVO TRUCK CORPORATION, S-405 08 Göteborg (SE)

(21) Appl. No.: 16/461,812

(22) PCT Filed: Nov. 25, 2016
(86) PCT No.: PCT/IB2016/001892

§ 371 Date: May 17, 2019

(51) Int. Cl. B60K 17/16; B60K 17/36

(52) U.S. Cl. CPC B60K 17/165; F16H 48/40; B60K 17/36

(57) ABSTRACT

The invention relates to an assembly for a differential unit of a vehicle. The assembly comprises: a first housing portion (20a) designed to be assembled with a second housing portion for forming a differential carrier housing (20); a first and a second supporting devices (30, 301, 302), each comprising a main portion having substantially the shape of a ring for receiving in use a differential housing (24). Each of the supporting devices (301, 302) is made as a single piece which is a piece separate from the first housing portion (20a) and secured to said first housing portion (20a).

### BACKGROUND AND SUMMARY

The invention relates to an assembly for a differential unit of a vehicle. The invention also relates to a differential unit comprising such an assembly, to an axle comprising such a differential unit, and to a vehicle comprising such an axle.

The invention can be applied in heavy-duty vehicles, such as trucks, buses and construction equipment.

A vehicle such as a truck is generally equipped with one or several differential units on its driven axles.

A differential unit typically comprises a differential carrier housing which is made of a first housing portion assembled with a second housing portion, and which contains the differential mechanism, i.e.: a crown wheel driven by an input shaft, a differential arranged inside the crown wheel and comprising pinions and gears, and a differential housing containing the differential and part of drive shafts connected to a wheel of the vehicle directly or through a hub reduction.

The differential housing is rotatably mounted in the differential carrier housing. To that end, the first differential carrier housing portion (hereafter “first housing portion”) comprises a first and a second supporting devices each comprising a main portion having substantially the shape of a ring, for receiving a bearing mounted around the differential housing surrounding the drive shaft.

According to a known implementation, a supporting device is made of a first half ring which is made as a single piece with the first housing portion, and a second half ring which is manufactured as a separate piece and subsequently secured to the first half ring. This implementation has several drawbacks. In particular, it requires the use of foundry cores for manufacturing the first housing portion and the first half ring, which is complicated and expensive. Besides, the half rings needs to be paired after they have been machined together in the assembled position, to ensure proper operation of the differential unit. Moreover, having a supporting device made of two separate parts may lead to the ring being less rigid and becoming oval over time, which would result in a malfunctioning of the differential unit.

According to another known implementation, a supporting device is made of as a single piece with the first housing portion. Such an implementation also requires the use of foundry cores.

It is desirable to provide an improved differential unit for a vehicle.

More specifically, it is desirable to provide a differential unit for a vehicle which is advantageous as compared to the prior art in terms of manufacturing process and durability.

To that end, and according to a first aspect, the invention concerns an assembly for a differential unit of a vehicle, the assembly comprising:

a first housing portion designed to be assembled with a second housing portion for forming a differential carrier housing;

a first and a second supporting devices, each comprising a main portion having substantially the shape of a ring for receiving in use a differential housing containing a differential and at least partially two drive shafts having a first end connected to the differential and a second end connected, directly or indirectly, to at least one wheel of the vehicle;

wherein each of the supporting devices is made as a single piece which is a piece separate from the first housing portion and secured to said first housing portion.

By the provision of a supporting device made as a single piece, i.e. not made of several parts secured to one another, no pairing of parts is necessary and, besides, the risk that the supporting devices of the invention become deformed is reduced.

Another significant advantage of the invention, which comes from the fact that the supporting devices are initially pieces separate from the first housing portion, is that the assembly can be manufactured without foundry cores. Indeed, possible recesses or holes can be formed in the supporting devices and/or in the first housing portion when they are separate pieces, which is far easier than when these parts are a single piece, or can be created by the manner in which these parts are secured.

In practice, the first and a second supporting devices, as well as the first housing portion, can be made separately by casting of a metal.

The first housing portion can have an assembling surface for cooperation with an assembling surface arranged on the second housing portion, and a first and second coupling surfaces for cooperation with a coupling surface of the first and second supporting devices, respectively.

The assembling surface of the first housing portion may be a substantially planar peripheral surface. This surface may be formed on an inner face of an outer flange of the first housing portion.

The first and second coupling surfaces on the first housing portion and the coupling surfaces on the first and a second supporting devices may be substantially planar.

In an embodiment, the assembling surface of the first housing portion and the first and second coupling surfaces on the first housing portion lie substantially in the same plane. Such an embodiment is particularly advantageous because it makes the surface machining of the first housing portion significantly easier.

The entire first housing portion can be located on one side of said plane. In other words, the first housing portion has no parts protruding in the inner direction from this plane. This also contributes to making the surface machining easier.

In an embodiment, the first housing portion is devoid of parts formed by foundry cores.

The ring-shaped main portion of each of the first and a second supporting devices can have an inner thread for receiving a nut of the differential unit. Because the ring-shaped main portion is made as a single piece, there is no need to first assemble two half rings, machine the thread, disassemble the supporting device, pairing the two half rings to ensure they will fit each other when the differential unit will be used, and then assemble the two half rings again for making the differential unit. Furthermore, a supporting device made as a single piece is more robust and less likely to become oval, which ensures the parts received in said supporting devices remains efficiently secured.

At least one of the first and a second supporting devices can comprise a lubricant collector. Such a lubricant collector can collect the lubricant which is splashed all over in the differential carrier housing by means of the crown wheel rotation, the collected lubricant being then directed to the various parts of the system which require lubrication.

According to a second aspect, the invention relates to a differential unit comprising a differential carrier housing and, inside the differential carrier housing:

a differential comprising differential side pinions fitted on a joint cross of the differential and two differential side gears each connected to at least one differential side pinion and to a drive shaft capable of being connected to at least one wheel of a vehicle, outside the differential carrier housing;

a differential housing containing the differential and at least partially the drive shafts;

a crown wheel having a longitudinal axis, said crown wheel is arranged to be driven in rotation around said longitudinal axis by an input shaft, said crown wheel is connected to the joint cross of said differential in a rotationally fixed manner, said crown wheel is secured to the differential housing and said crown wheel is arranged substantially around the differential housing.

on both sides of the crown wheel, a bearing having an inner ring arranged around the differential housing and having an outer ring.

The differential carrier housing of the differential unit comprises an assembly as previously described. The outer ring of one bearing is arranged in the ring-shaped main portion of the first supporting device and the outer ring of the other bearing is arranged in the ring-shaped main portion of the second supporting device.

Said inner ring arranged around the differential housing can be a ring mounted on the differential housing or can be integral with the differential housing. Each outer ring arranged in the supporting device can be a ring mounted in the supporting device or can be integral with the supporting device.

The differential unit may further comprise an input shaft having an axis orthogonal to the longitudinal axis of the crown wheel, the input shaft being driven in rotation around its axis by an engine of the vehicle and being mourned in a through bore of the first housing portion by means of at least two bearings, the input shaft having an rear end pinion meshing with the crown wheel. According to the invention the input shaft is preferably mounted in a through bore of the first housing portion by means of only two bearings and the differential unit is preferably devoid of any bearing mounted on the rear end portion of the input shaft, rearwards of the rear end pinion.

In addition and in order to simplify the mounting process and reducing the cost of the differential unit, as compared to the prior art, this arrangement allows simplifying the shape of the second supporting device, which in the prior art conventionally comprises a bore for receiving such an additional bearing for guiding the rear end portion of the input shaft.

According to a third aspect, the invention relates to an axle which comprises a differential unit as previously described, the axle comprising an axle housing which forms the second housing portion designed to be assembled to the first housing portion and which contains the drive shafts, the axle further comprising a wheel connected to one end of each drive shaft. Said axle may also comprise hub reduction gears arranged between said at least one wheel and said one end of each drive shaft.

According to a fourth aspect, the invention relates to a vehicle comprising at least one axle as previously described.

Further advantages and advantageous features of the invention are disclosed in the following description.

### BRIEF DESCRIPTION OF THE DRAWINGS

With reference to the appended drawings, below follows a more detailed description of embodiments of the invention cited as examples.

In the drawings:

FIG. 1 is a schematic drawing of an underside of a vehicle showing a rear axle including a differential unit according to an embodiment of the invention:

FIG. 2 is a perspective view of the differential unit, with part of the differential carrier housing being removed;

FIG. 3 is a perspective view of the differential unit of FIG. 2, cut in a plane which is substantially vertical and which includes a longitudinal axis of the differential unit;

FIGS. 4a, 4b and 4c are perspective views of a first supporting device forming part of an assembly according to the invention;

FIGS. 5a, 5b and 5c are perspective views of a second supporting device forming part of an assembly according to the invention;

FIG. 6 shows the differential unit of FIG. 2, cut in a plane which is substantially vertical and orthogonal to the longitudinal axis of the differential unit;

FIG. 7 is a perspective view from the inner side of a first housing portion forming part of an assembly according to the invention.

### DETAILED DESCRIPTION

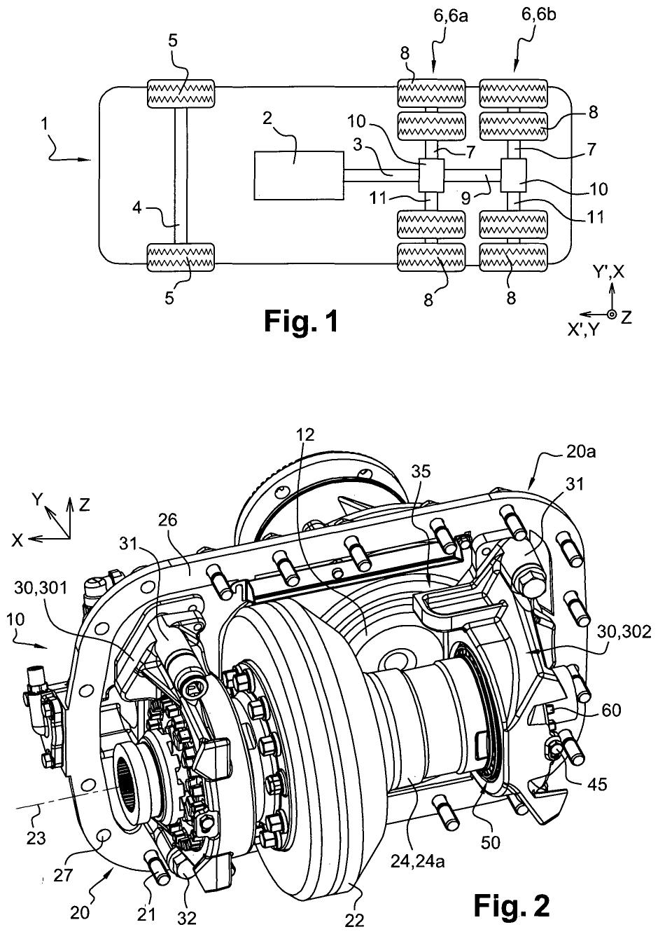

As shown in FIG. 1, a vehicle 1 comprises a front axle 4 connected to front wheels 5, at least one rear axle 6 and an engine 2 that drives an input shaft 3.

The or each rear axle 6 comprises an axle housing 7 containing a differential unit 10, which includes a differential 15, and two drive shafts 11. Each drive shaft 11 has a first end connected 10 the differential 15 and a second end connected to at least one wheel 8. The second end of the drive shaft is generally connected to said at least one wheel 8 via hub redaction gears, in the illustrated embodiment, the vehicle 1 comprises a first driven rear axle 6a and a second driven rear axle 6b located rearwards from the first driven rear axle 6a, each rear axle 6a, 6b comprising at least one wheel 8 on either side. An additional shaft 9 connects the input shaft 3 to the differential unit 10 of the second driven rear axle 6b, through the differential unit 10 of the first driven rear axle 6a, and is the input shaft for the differential unit 10 of the second driven rear axle 6b.

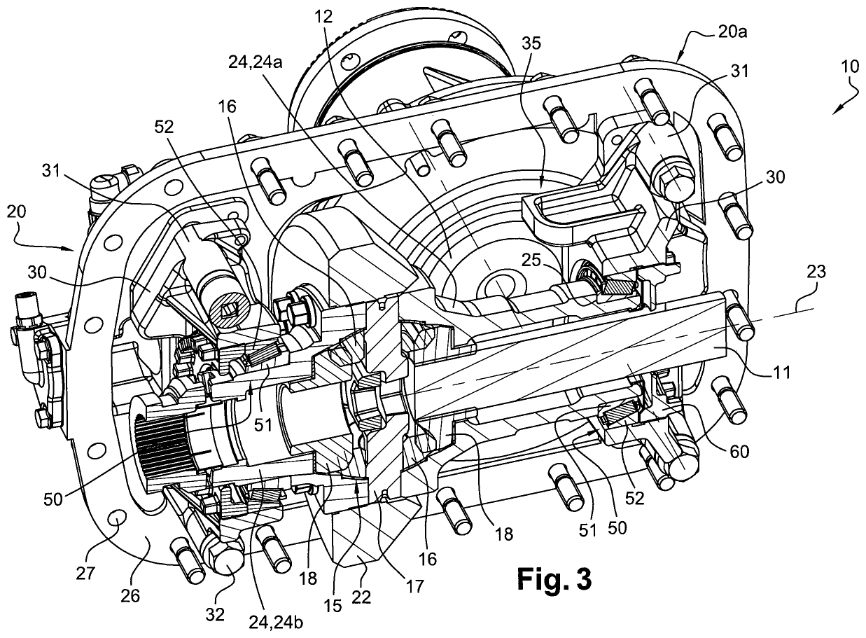

With reference to FIGS. 2 and 3, the differential unit 10 comprises a differential carrier housing 20—hereafter called “housing 20” for simplicity purposes.

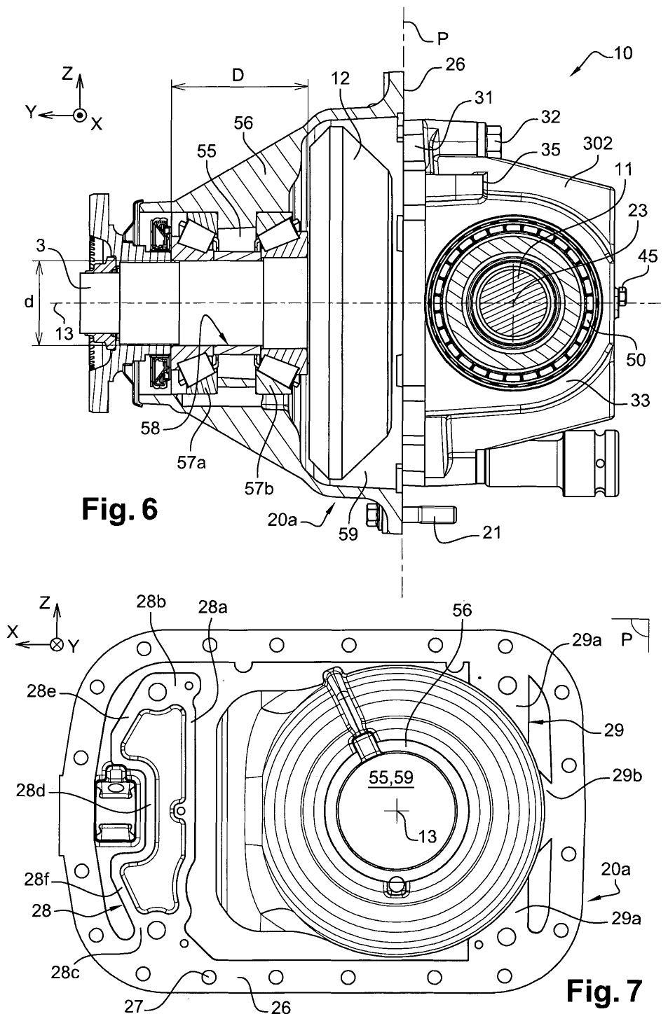

The housing 20 is made of a first housing portion 20a shown in FIG. 6, and a second housing portion which can be formed by a portion of the axle housing 7, the first and second housing portions being secured to one another by means of appropriate fasteners 21.

In the illustrated embodiment, the first housing portion 20a has an assembling surface 26 for cooperation with an assembling surface arranged on the second housing portion. Preferably, the assembling surface 26 of the first housing portion 20a can be a substantially planar peripheral surface, as can be seen in FIG. 7. For example, the housing portions can substantially form half shells secured along their peripheral edge by bolts inserted in holes 27.

Except in FIG. 1, only the first housing portion 20a of the housing 20 has been illustrated, so that the inside of said housing 20 can be seen.

Inside the housing 20 is located a crown wheel 22 having a longitudinal axis 23. The crown wheel 22 is driven in rotation around said longitudinal axis 23 by the input shaft 3, by engagement of teeth arranged on a pinion 12 mounted on said input shaft 3 and teeth arranged on the crown wheel 22 (the teeth are not illustrated).

As shown in FIG. 2, the longitudinal direction X is defined as a direction parallel to the longitudinal axis 23 of the crown wheel 22. In the operating position, i.e. when the differential unit is mounted under the vehicle 1, as shown in FIG. 1, the longitudinal direction X corresponds the transverse direction Y′ of the vehicle 1, i.e. the direction of the axles 4,6. Direction X is substantially horizontal when the vehicle 1 is on a horizontal surface.

Besides, the transverse direction Y is defined as the direction which is orthogonal to the longitudinal direction X and substantially horizontal when the vehicle 1 is on a horizontal surface. Direction Y corresponds the longitudinal direction X′ of the vehicle 1.

Moreover, direction Z is defined as the vertical direction—when the vehicle 1 is on a horizontal surface.

The invention will be described when the vehicle 1 is on a horizontal surface.

The differential unit 10 further comprises, inside the housing 20, a differential housing 24 which contains the differential 15 and part of the drive shafts 11, namely the part of each drive shaft 11 which is located near the first end of said drive shaft 11. The crown wheel 22 is secured to the differential housing 24 and is arranged generally around the differential. The differential housing 24 may be made of two parts 24a, 24b each forming a sleeve around the corresponding drive shaft 11, said parts 24a, 24b can be fastened on both sides of the crown wheel 22.

The differential 15 is arranged inside the differential housing 24. The differential comprises differential side pinions 16 also known as planet gears, for example four differential side pinions, which are fitted on a joint cross 17 commonly attached inside the differential housing 24, and two differential side gears 18. Each differential side gear 18 meshes with at least one differential side pinion 16 and is fastened to a first end of one of the drive shafts 11. Said joint cross 17 has commonly four legs arranged as a cross and on each leg is fitted a differential side pinion 16.

The crown wheel 22, differential 15, and differential housing 24 are rotating parts inside and with respect to the housing 20. They are mounted on the inner side of the first housing portion 20a by means of two supporting devices 30. Each supporting device 30 is seemed to the first housing portion 20a and carries a bearing 50 having an inner ring 51 arranged around the differential housing 24, 24a, 24b and an outer ring 52 arranged inside the supporting device 30. The bearings 50 are preferably conical bearings. The inner ring 51 arranged around the differential housing 24, 24a, 24b can be a ring mounted on the differential housing or can be integral with the differential housing. The outer ring 52 arranged inside the supporting device 30 can be a ring mounted in the supporting device 30 or can be integral with the supporting device 30.

The supporting devices 30 are located on both sides of the crown wheel 22. More precisely, there is provided a first supporting device 301 and a second support device 302, the second support device 302 being located on the same side of the crown wheel 22 as the input shaft 3.

As shown in FIG. 6, the input shaft 3 has an axis 13 which is parallel to the transverse direction Y, i e the longitudinal direction X′ of the vehicle 1. The input shaft 3 is mounted in a through bore 55 of the first housing portion 20a. The through bore 55 may be arranged in a protruding portion 56 of the first housing portion 20a which extends in a direction opposite the differential 15. The input shaft 3 is mounted in the through bore 55 by means of at least two bearings, namely a from bearing 57a and a rear bearing 57b, which can be taper roller bearings.

The pinion 12 such as represented on FIGS. 2 and 6 and which meshes with the crown wheel 22 is mounted on the rear end portion of the input shaft 3 (the term “rear” referring to the position in relation to the vehicle 1). The pinion 12 is located inside a cavity 59 of the protruding portion 56 of the first housing portion 20a which opens both towards the through bore 55 and towards the differential 15.

In a preferred arrangement of the invention that can be seen on FIG. 6, the input shaft 3 is mounted in the through bore 55 by means of only two bearings 57a, 57b, that are both arranged on the front side of the pinion 12, and the differential unit 10 is devoid of any bearing mounted on the rear end portion of the input shaft 3, rearwards of the rear end pinion 12.

As compared to prior art differential units, suppressing such a rear bearing is possible without impairing the operation of the differential unit although the input shaft 3 is a cantilevered piece. The simplified structure of the invention may require providing bearings 57a, 57b which are larger and or which are spaced apart from one another by a higher distance, as compared to the prior art. According to an implementation, as shown in FIG. 6, the differential unit 10 may be designed such that D>1.5 d, where:

D is the axial length of the bearing area 58 provided by the bearings, from the front end of the front bearing 57a to the rear end of the rear bearing 57b;

and d is the diameter of the input shaft 3 in said bearing area 58.

Having a differential unit 10 devoid of any bearing mounted on the rear end portion of the input shaft 3, rearwards of the rear end pinion 12, as explained above, can further allow to simplify the structure of the supporting devices 30. Indeed, such an additional bearing, when present in prior an differential units, can generally be mounted in a bore of the second supporting device. With the invention, as this additional bearing is not provided, no specific shapes need to be provided on the supporting device for that purpose.

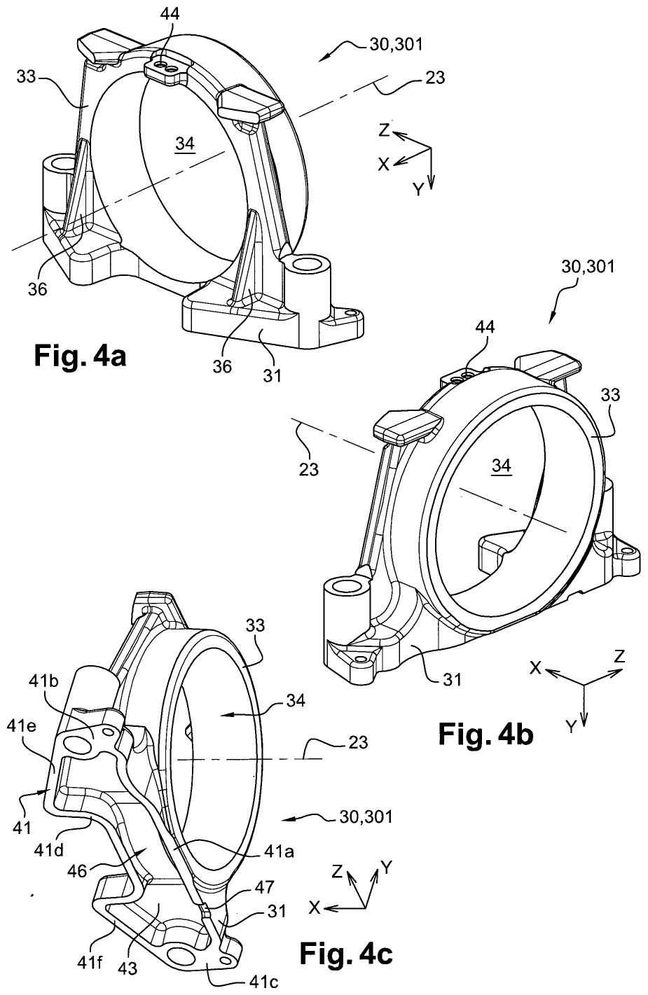

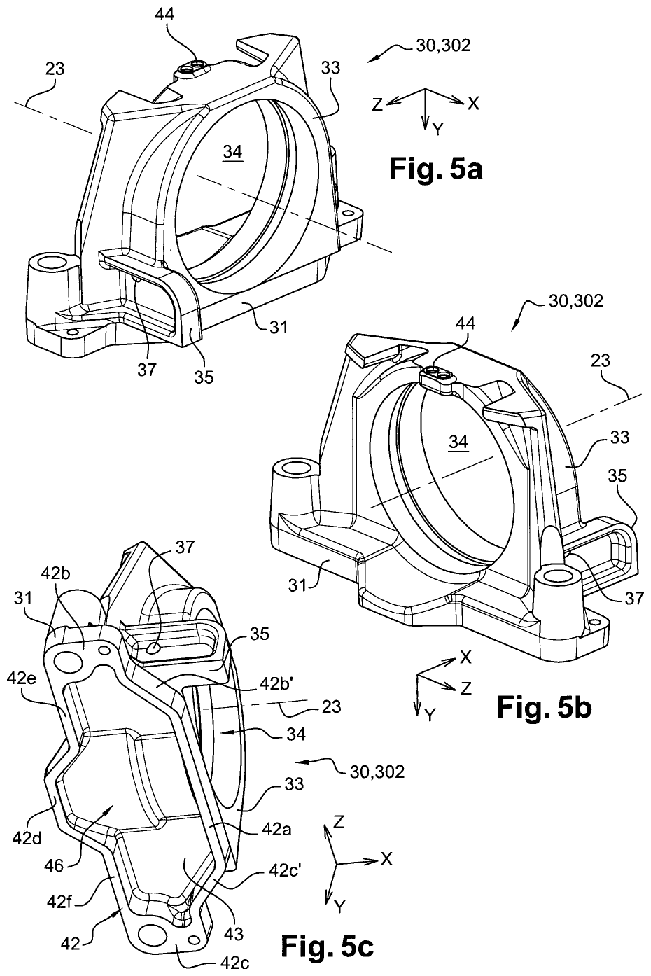

The supporting devices 30, 301, 302 will now be described more precisely, with reference to FIGS. 4a to 5c.

Each supporting device 30 can comprise a base 31 through which the supporting device 30 can be secured to the first housing portion 20a. To that end, in the illustrated embodiment, this base 31 includes two cylindrical sleeves each receiving a fastener 32 such as a bolt. Each supporting device 30 also comprises a main portion 33 which is substantially in the shape of a ring centred on the longitudinal axis 23, and which forms a circular opening 34 in which is mounted the outer ring 52 of the bearing 50. In other words, the main portion 33 of each supporting device 30 receives the differential housing 24, more specifically the main portion 33 of each supporting device 30 receives a part 24a, 24b of the differential housing 24.

One or several reinforcing walls 36 may be provided on a supporting device 30, for example between the ring-shaped main portion 33 and the base 31 of the first supporting device 301, as shown on FIG. 4a.

In use, the housing 20 contains a lubricant bath in which the crown wheel 22 soaks. When the crown wheel 22 is rotated, it projects lubricant from the bath inside the housing thanks to its teeth. Part of this projected lubricant directly contacts some constituents and therefore lubricate them. Another part of this projected lubricant can be collected by a collector 35 arranged on one of the supporting devices 30. In the disclosed embodiment, the collector 35 is arranged on the second supporting device 302, as shown on FIGS. 5a-5c.

The collector 35 can have a substantially rectangular and planar bottom wall which is substantially horizontal in use, a peripheral wall and an open upper surface. As shown on FIG. 2, the collector 35 can extend in the longitudinal direction X from the main portion 33 of the second supporting device 302, towards the differential 15, in use.

The collector 35 can be offset with respect to the longitudinal axis 23, for example both along the Y axis and the Z axis. More specifically, the collector 35 can tie located on the second supporting device 302 near to the base 31, and preferably above the longitudinal axis 23, in order to take advantage of gravity.

The bottom wall of the collector 35 includes a through hole 37. Moreover, specific arrangements can allow the collected lubricant flowing through the hole 37 to be directed to the differential 15, the constituents of which (especially the differential side pinions 16 and differential side gears 18) cannot be reached easily by the projected lubricant.

According to the invention, each of the supporting devices 30, 301, 302 is made as a single piece which is a piece separate from the first housing portion 20a, and secured to said first housing portion 20a.

As explained above, this allows making the supporting devices 30, on the one hand, and the first housing portion 20a, on the second hand, possibly with fairly complex shapes, without using foundry cores. This further results in the supporting devices 30 having a higher mechanical strength and being less likely to become deformed.

Once the first housing portion 20a and the supporting devices 30 have been manufactured separately, the supporting devices 30 are assembled and fastened to the housing portion 20a. To that end, the housing portion 20a has a first coupling surface 28 for cooperation with a coupling surface 41 of the first second supporting device 301, and a second coupling surface 29 for cooperation with a coupling surface 42 of the second supporting device 302.

As shown on FIGS. 4a-5c and 7, the coupling surfaces 41, 42 on the supporting devices 301, 302 can be arranged on the side of the base 31 which is opposite the main portion 33. In a preferred embodiment, the coupling surfaces 41, 42 can be substantially planar, as are the corresponding first and second coupling surfaces 28, 29 on the first housing portion 20a.

The coupling surfaces 41, 42 can be formed by a peripheral border, projecting in the transverse direction Y from a wall 43 of the base 31 which extends in a plane (X,Z). In other words, a cavity 46 is formed on the base 31, said cavity opening towards the first housing portion 20a in the mounted position. Such a cavity 46 provides material saving. Because each of the supporting devices 30 is made as a single piece which is a piece separate from the first housing portion 20a, and subsequently secured to said first housing portion 20a, this material saving can be obtained without requiring the use of foundry cores.

As shown in FIG. 4c, and with reference to the mounted position, the first coupling surface 41—arranged on the first supporting device 301—comprises:

a substantially straight portion 41a, extending along direction Z, and located closest to the input shaft 3;

an upper straight portion 41b and a lower straight portion 41c both extending along direction X from the substantially straight portion 41a, each including a hole for receiving one fastener 32;

a section facing the substantially straight portion 41a and joining the upper and lower straight portions 41b, 41c, made of: a central C-shaped portion 41d opening towards the outside of the cavity 46, and two inclined portions 41e, 41f each joining one of the upper and lower straight portions 41b, 41c and one free end of the central C-shaped portion 41d.

The first coupling surface 28 formed on the housing portion 20a, designed to cooperate with the first coupling surface 41 of the first supporting device 301, may have a similar shape, as shown on FIG. 7, namely:

a substantially straight portion 28a, extending along direction Z, and located closest to the input shaft 3;

an upper straight portion 28b and a lower straight portion 28c both extending along direction X from the substantially straight portion 28a, each including a hole for receiving one fastener 32;

a section facing (he substantially straight portion 28a and joining the upper and lower straight portions 28b, 28c, made of: a central C-shaped portion 28d and two inclined portions 28e, 28f each joining one of the upper and lower straight portions 28b, 28c and one free end of the central C-shaped portion 28d.

The first coupling surface 28 can have some parts connected to the assembling surface 26. In the embodiment of FIG. 7, for example, the lower straight portion 28c of the first coupling surface 28 is arranged in the continuity of the assembling surface 26.

A notch 47 may be provided in the first coupling surface 41, for example on the substantially straight portion 41a. Such a notch 47 can allow lubricant to flow between the first supporting device 301 and the first housing portion 20a.

As shown in FIG. 5c, and with reference to the mounted position, the second coupling surface 42—arranged on the second supporting device 302—comprises:

a substantially straight central portion 42a, extending along direction Z, and located closest to the input shaft 3;

an upper straight portion 42b and a lower straight portion 42c both extending along direction X, each including a hole for receiving one fastener 32;

an upper inclined portion 42b′ and a lower inclined portion 42c′ which respectively connect the upper straight portion 42b and the lower straight portion 42c to the substantially straight central portion 42a;

a section facing the substantially straight central portion 42a and joining the upper and lower straight portions 42b, 42c, made of: a central C-shaped portion 42d opening towards the cavity 46, and two substantially straight portions 42e, 42f each joining one of the upper and lower straight portions 42b, 42c and one free end of the central C-shaped portion 42d. The central C-shaped portion 42d is designed to strength further the base 31 of the second supporting device 302.

The second coupling surface 29 formed on the housing portion 20a, designed to cooperate with the second coupling surface 42 of the second supporting device 302, may comprise:

a substantially straight strip portion 29a, extending along direction Z from one side of the assembling surface 26 towards the opposite side of said assembling surface 26, the substantially straight strip portion 29a being interrupted by the cavity 59 and including a hole for receiving one fastener 32;

a longitudinal portion 29b extending along direction X from the cavity 59 towards the assembling surface 26.

The second coupling surface 29 can have some parts connected to the assembling surface 26. In the embodiment of FIG. 7, for example, the substantially straight strip portion 29a and the longitudinal portion 29b are both arranged in the continuity of the assembling surface 26.

The substantially straight strip portion 29a is designed to cooperate with the upper and lower straight portions 42b, 42c of the second coupling surface 42 arranged on the second supporting device 302, while the longitudinal portion 29b is designed to cooperate with the central C-shaped portion 42d.

According to an advantageous embodiment, and as shown in FIG. 7, the assembling surface 26 of the first housing portion 20a and the first and second coupling surfaces 28, 29 on the first housing portion 20a lie substantially in the same plane P. Furthermore, the entire first housing portion 20a can be located on one side of said plane P, as is best seen in FIG. 6. These features both contribute to making the surface machining of the first housing portion 20a easier.

In the mounted position, the supporting devices 30 are fastened to the first housing portion 20a and each receive a part 24a, 24b of the differential housing 24, via the corresponding bearing 50. In practice, the bearing 50 is mounted around the differential housing 24, the inner ring 51 resting against a radial shoulder 25 arranged on the differential housing 24, and facing opposite the differential 15.

As shown on FIGS. 2 and 3, the differential unit 10 further comprises a nut 60 having an outer thread (not shown) for cooperation with an inner thread (not shown) of the ring-shaped main portion 33 of the supporting device 30, so that the nut 60 can be threaded in the circular opening 34. The nut 60 also comprises a central hole designed to receive the drive shaft 11. The nut 60 is threaded with respect to the circular opening 34. i.e. rotated, so as to provide an appropriate preload—i.e. axial pressure—on the outer ring 52 of the bearing 50. In other words, the bearing 50 is pushed against the shoulder 25 by the nut 60. The nut 60 is maintained in this position by means of appropriate fasteners 45 inserted through holes 44 of the supporting devices 30.

The inner thread of the ring-shaped main portion 33, for cooperating with the nut 60, can only be made when the ring is actually formed. Because each supporting device 30 of the invention is made as a single piece, the process does not include:

a preliminary step for mounting several parts to one another to form the ring-shaped main portion 33;

and a step of pairing the parts to ensure that the parts which will be secured to one another to form the supporting device 30 were threaded together, to avoid malfunctioning of the differential unit 10.

Therefore, the invention provides an improved differential unit in terms of manufacturing and mounting process, reliability and robustness.

It is to be understood that the present invention is not limited to the embodiments described above and illustrated in the drawings; rather, the skilled person will recognize that many changes and modifications may be made within the scope of the appended claims.

1. An assembly for a differential unit of a vehicle, the assembly comprising:
a first housing portion designed to be assembled with a second housing portion for forming a differential carrier housing;
a first and a second supporting devices, each comprising a main portion having substantially the shape of a ring for receiving in use a differential housing containing a differential and at least partially two drive shafts having a first end connected to the differential and a second end connected to at least one wheel of the vehicle;
wherein each of the supporting devices is made as a single piece which is a piece separate from the first housing portion and secured to the first housing portion.

2. The assembly according to claim 1, wherein the first housing portion has an assembling surface for cooperation with an assembling surface arranged on the second housing portion, and a first and second coupling surfaces for cooperation with a coupling surface of the first and second supporting devices, respectively.

3. The assembly according to claim 2, wherein the assembling surface of the first housing portion is a substantially planar peripheral surface.

4. The assembly according to claim 2, wherein the first and second coupling surfaces on the first housing portion and the coupling surfaces on the first and a second supporting devices are substantially planar.

5. The assembly according to claim 3, wherein the first and second coupling surfaces on the first housing portion and the coupling surfaces on the first and a second supporting device are substantially planar, and the assembling surface of the first housing portion and the first and second coupling surfaces on the first housing portion lie substantially in the same plane.

6. The assembly according to claim 5, wherein the entire first housing portion is located on one side of the plane.

7. The assembly according to claim 1, wherein the first housing portion is devoid of parts formed by foundry cores.

8. The assembly according to claim 1, wherein the ring-shaped main portion of each of the first and a second supporting devices has an inner thread for receiving a nut of the differential unit.

9. The assembly according to claim 1, wherein at least one of the first and a second supporting devices comprises a lubricant collector.

10. A differential unit comprising a differential carrier housing and, inside the differential carrier housing:
a differential comprising differential side pinions fitted on a joint cross of the differential and two differential side gears each connected to at least one differential side pinion and to a drive shaft capable of being connected to at least one wheel of a vehicle, outside the differential carrier housing;
a differential housing containing the differential and at least partially the drive shafts;
a crown wheel having a longitudinal axis, the crown wheel being arranged to be driven in rotation around the longitudinal axis by an input shaft, the crown wheel being connected to the joint cross of the differential in a rotationally fixed manner, the crown wheel being secured to the differential housing and the crown wheel being arranged substantially around the differential housing;
on both sides of the crown wheel, a bearing having an inner ring arranged around the differential housing and having an outer ring;
wherein the differential carrier housing of the differential unit comprises an assembly according to claim 1, the outer ring of one bearing being arranged in the ring-shaped main portion of the first supporting device and the outer ring of the other bearing being arranged in the ring-shaped main portion of the second supporting device.

11. The differential unit according to claim 10, further comprising an input shaft having an axis orthogonal to the longitudinal axis of the crown wheel, the input shaft being driven in rotation around its axis by an engine of the vehicle and being mounted in a through bore of the first housing portion by means of two bearings, the input shaft having an rear end pinion meshing with the crown wheel, wherein the differential unit is devoid of any bearing mounted on the rear end portion of the input shaft, rearwards of the rear end pinion.

12. The differential unit according to claim 11, wherein D>1.5 d, where:
D is the axial length of the bearing area provided by the bearings, from the front end of the front bearing to the rear end of the rear bearing;
and d is the diameter of the input shaft in the bearing area.

13. An axle wherein it comprises a differential unit according to claim 10, the axle comprising an axle housing which forms the second housing portion designed to be assembled to the first housing portion and which contains the drive shafts the axle further comprising at least one wheel connected to one end of each drive shaft and eventually comprising hub reduction gears arranged between the at least one wheel and the one end of each drive shaft.

14. A vehicle comprising at least one axle according to claim 13.
